(19) United States
(12) Patent Application Publication
(10) Pub. No.: US 2017/0256063 A1
(43) Pub. Date: Sep. 7, 2017

(54) APPARATUS FOR TRACKING TRAJECTORY OF HIGH-SPEED MOVING OBJECT AND METHOD THEREFOR

(71) Applicant: ELECTRONICS AND TELECOMMUNICATIONS RESEARCH INSTITUTE, Daejeon (KR)

(72) Inventors: Seong Min BAEK, Daejeon-si (KR); Myung Gyu KIM, Daejeon-si (KR); Ye Jin KIM, Daejeon-si (KR); Sung Jin HONG, Daejeon-si (KR); Il Kwon JEONG, Daejeon-si (KR)

(21) Appl. No.: 15/242,746

(22) Filed: Aug. 22, 2016

(30) Foreign Application Priority Data
Mar. 4, 2016 (KR) 10-2016-0026127

(51) Int. Cl. G06T 7/20; G06T 7/00

(52) U.S. Cl. CPC G06T 7/20; G06T 7/0048; G06T 7/0044; G06T 7/0053; G06T 7/0065; G06T 2207/30224; G06T 2207/30241

(57) ABSTRACT

An object trajectory tracking apparatus for tracking three-dimensional position of a high-speed moving instrument, i.e., a high-speed moving object for which it is difficult to acquire actual depth information, and a moving path thereof when information is extracted by utilizing a single depth sensor in a swing motion of sport in which a predetermined instrument is used by hand, and method therefor. The apparatus includes grid information generation unit, shadow area determination unit, initial object position information generation unit, object position estimation unit, and three-dimensional trajectory restoration unit, tracks three-dimensional route of an object, for which it is difficult to acquire depth information, in a fast sports motion such that information that allows user to correct and learn motion can be provided, and calculates a three-dimensional position and route calculated such that information required for practicing a more accurate swing motion can be provided.

### CROSS-REFERENCE TO RELATED APPLICATION(S)

This application claims priority from Korean Patent Application No. 10-2016-0026127, filed on Mar. 4, 2016, in the Korean Intellectual Property Office, the disclosure of which is incorporated herein by reference in its entirety.

### BACKGROUND

1. Field

The present disclosure relates to an object trajectory tracking apparatus for tracking a three-dimensional position of a high-speed moving instrument, i.e., a high-speed moving object for which it is difficult to acquire actual depth information, and the moving path thereof, when information is extracted from a swing motion of a sport in which a predetermined instrument is used by a hand by utilizing a single depth sensor, and a method therefor.

2. Description of Related Art

Generating a two-dimensional trajectory by tracking a hand and a particular area of an instrument (e.g., a head area of a golf club) from a two-dimensional image using color values has been used as a conventional method for tracking a trajectory of a high-speed moving object.

Alternatively, an optical capture technology in which an inertia sensor is attached to or worn on a user's body or an instrument to generate a three-dimensional trajectory of the instrument through movements of the inertia sensor or an attached marker is tracked using a plurality of image sensors to generate a three-dimensional trajectory has been used.

However, a limitation exists in the technology above in that tracking is possible only when a sensor or a marker is attached or worn on a user's body or an instrument.

In addition, although technologies that acquire depth information of a user to inform the user of motion being performed by the user, a difference from an expert's posture, etc. exist in the field of tracking a trajectory of a high-speed moving object by performing motion analysis using a depth sensor, a limitation exists in that information on an instrument used by the user, that is, not the user's motion, cannot be tracked.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is directed to providing an apparatus and method in which a three-dimensional position and a trajectory of a high-speed moving object, for which it is difficult to acquire depth information, can be tracked only using a single depth sensor without an attachment or wearing of an inertia sensor or a marker.

According to an embodiment of the present disclosure, an apparatus for tracking a trajectory of a high-speed moving object includes a grid information generation unit that generates a grid on a bottom plane and a rear plane using depth information extracted from a background of an image and projects three-dimensional position information extracted from the background of the image on the grid to calculate the number of points projected on the grid to thereby generate grid information, a shadow area determination unit that extracts three-dimensional position information from an image that has captured a user's swing motion to generate swing motion information including the number of points projected on the grid and compares the number of projected points included in the grid information with the number of projected points included in the swing motion information to determine a shadow area of an object, an initial object position information generation unit that uses the determined shadow area of the object to form a virtual swing plane based on the fact that a swing motion is performed in a swing plane and uses the formed virtual swing plane to generate information on an initial position of the object, an object position estimation unit that uses the generated initial position information of the object and shortest route information included in the swing motion information to estimate information on a position and speed of a user's hand and calculates an actual three-dimensional position of the object using the estimation, and a three-dimensional trajectory restoration unit that uses the calculated actual three-dimensional position of the object to restore three-dimensional trajectories of the user's hand and the object by curve fitting.

According to an embodiment of the present disclosure, the grid information generation unit may include a grid generation unit that disposes a background in a three-dimensional space according to information on a principal point and a focal length of a camera included in the depth information extracted from the background of the image and generates a grid on a bottom plane and a rear plane of the disposed background according to a preset grid size, and a grid projection point calculation unit that projects three-dimensional points included in the three-dimensional position information extracted from the background of the image on the generated grid and calculates the number of the points projected on the grid to generate grid information.

According to an embodiment of the present disclosure, the shadow area determination unit may search for an entire shadow area and a shadow area of the user to determine the shadow area of the object and may exclude the shadow area of the user from the searched entire shadow area.

According to an embodiment of the present disclosure, the initial object position information generation unit may include a swing plane formation unit that forms a virtual swing plane using an initial position of a designated object and a shadow area of an object having the highest y-axis value to track a position of the user's hand, and an initial object position setting unit that sets, as an initial position of the object, a point at which a line connecting the origin of a coordinate system of the camera to the shadow area of the object meets the formed swing plane.

According to an embodiment of the present disclosure, the object position estimation unit may set a point at which a position of a shadow of an object is generated on an XZ plane as a starting point of tracking the user's hand to track a position of the user's hand, may select a point closest to the initial position of the object in the swing plane and define the point as an initial position of the user's hand, and may use a position and speed of the user's hand calculated in the current frame (t frame) to track the position of the hand using a previous frame (t−1 frame) in the case of a downward swing and using the next frame (t+1 frame) in the case of an upward swing.

According to an embodiment of the present disclosure, the three-dimensional trajectory restoration unit may compensate for the initial position of the user's hand using the length of an instrument used by the user when the actual three-dimensional position information of the object is determined and compensate for the position of the hand to be a position moved by the length of the instrument from the actual three-dimensional position of the object when a position difference between before and after the compensation is a preset threshold value or larger.

According to an embodiment of the present disclosure, the three-dimensional trajectory restoration unit may use a spline curve or an elliptic equation for the curve fitting and use the spline curve or the elliptic equation to calculate trajectories of the user's hand and the object.

According to an embodiment of the present disclosure, a method for tracking a trajectory of a high-speed moving object includes generating grid information by generating a grid on a bottom plane and a rear plane using depth information extracted from a background of an image and projecting three-dimensional position information extracted from the background of the image on the grid to calculate the number of points projected on the grid, determining a shadow area of an object by extracting three-dimensional position information from an image that has captured a user's swing motion to generate swing motion information including the number of points projected on the grid and comparing the number of projected points included in the grid information with the number of projected points included in the swing motion information, generating information on an initial position of the object by using the determined shadow area of the object to form a virtual swing plane based on the fact that a swing motion is performed in a swing plane and using the formed virtual swing plane, calculating an actual three-dimensional position of the object using estimation by using the generated initial position information of the object and the shortest route information included in the swing motion information to estimate information on a position and speed of a user's hand, and restoring three-dimensional trajectories of the user's hand and the object by curve fitting using the calculated actual three-dimensional position of the object.

According to an embodiment of the present disclosure, the generating of the grid information may include arranging a background on a three-dimensional space according to information on a principal point and a focal length of a camera included in the depth information extracted from the background of the image and generating a grid on a bottom plane and a rear plane of the arranged background according to a preset grid size, and projecting, on the generated grid, three-dimensional points included in the three-dimensional position information extracted from the background of the image and calculating the number of the points projected on the grid to generate grid information.

According to an embodiment of the present disclosure, the determining of the shadow area of the object may include searching for an entire shadow area and a shadow area of the user to determine the shadow area of the object and excluding the shadow area of the user from the searched entire shadow area.

According to an embodiment of the present disclosure, the generating of the initial position information of the object may include forming a virtual swing plane using an initial position of a designated object and a shadow area of an object having the highest y-axis value to track a position of the user's hand, and setting, as an initial position of the object, a point at which a line connecting an origin of a coordinate system of the camera to the shadow area of the object meets the formed swing plane.

According to an embodiment of the present disclosure, the calculating of the actual three-dimensional position of the object may include setting a point at which a position of a shadow of an object is generated on an XZ plane as a starting point of tracking the user's hand to track a position of the user's hand, selecting a point closest to the initial position of the object on the swing plane and defining the point as an initial position of the user's hand, and using a position and speed of the user's hand calculated in the current frame (t frame) to track the position of the hand using a previous frame (t−1 frame) in the case of a downward swing and using the next frame (t+1 frame) in the case of an upward swing.

According to an embodiment of the present disclosure, the restoring of the three-dimensional trajectory of the object may include compensating for the initial position of the user's hand using the length of an instrument used by the user when the actual three-dimensional position information of the object is determined and compensating for the position of the hand to be a position moved by the length of the instrument from the actual three-dimensional position of the object when a position difference between before and after the compensation is a preset threshold value or larger.

According to an embodiment of the present disclosure, the restoring of the three-dimensional trajectory of the object may include using a spline curve or an elliptic equation for the curve fitting and using the spline curve or the elliptic equation to calculate trajectories of the user's hand and the object.

Other features and aspects will be apparent from the following detailed description, the drawings, and the claims.

### BRIEF DESCRIPTION OF THE DRAWINGS

FIG. 1 is a block diagram of an apparatus for tracking a trajectory of an object according to an embodiment of the present disclosure.

FIG. 2 is a detailed block diagram of a grid information generation unit shown in FIG. 1.

FIG. 3 is a detailed block diagram of an initial object position information generation unit shown in FIG. 1.

FIG. 4 is a view illustrating a generated grid and points projected on the grid according to an embodiment of the present disclosure.

FIG. 5 is a view illustrating an entire shadow area generated according to an embodiment of the present disclosure.

FIG. 6 is a view illustrating a shadow area of a user and a shadow area of an object generated according to an embodiment of the present disclosure.

FIG. 7 is a view illustrating a formed virtual swing plane and an initial three-dimensional position of a generated object according to an embodiment of the present disclosure.

FIG. 8A is a view illustrating estimating a position of a user's hand according to an embodiment of the present disclosure.

FIG. 8B is a view illustrating the position of the user's hand being erroneously estimated due to the hand being occluded.

FIG. 8C is a view illustrating compensating for the position of the user's hand using information on an initial position and speed of the user's hand according to an embodiment of the present disclosure.

FIG. 9 is a view illustrating tracking the three-dimensional positions of the user's hand and the object by curve fitting using actual three-dimensional positions of the object according to an embodiment of the present disclosure.

FIG. 10 is a view illustrating restoring three-dimensional trajectories of the user's hand and the object according to an embodiment of the present disclosure.

FIG. 11 is a flow chart illustrating a method of restoring the three-dimensional trajectories of the user's hand and the object according to an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, embodiments of the present disclosure will be described in detail with reference to the accompanying drawings so that those of ordinary skill in the art to which the present disclosure pertains can easily practice the present disclosure. However, the present disclosure may be implemented in various different forms and are not limited to the embodiments described herein.

In addition, to clearly describe the present disclosure, parts unrelated to the description have been omitted, and like reference numerals have been given to like parts throughout the specification.

Throughout the specification, when it is said that a certain part “includes” a certain element, this means that the certain part may further include another element instead of excluding another element unless particularly described otherwise.

Hereinafter, an apparatus for tracking a trajectory of a high-speed moving object and a method therefor according to an embodiment of the present disclosure will be described with reference to the drawings.

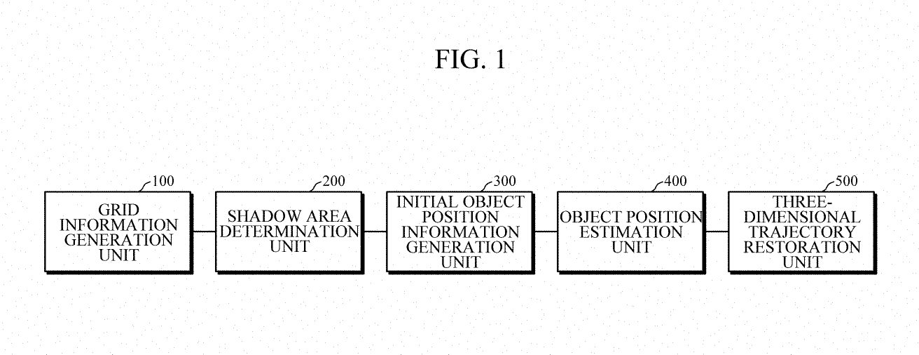

FIG. 1 is a block diagram of an object trajectory tracking apparatus 1000 according to an embodiment of the present disclosure.

Referring to FIG. 1, the object trajectory tracking apparatus 1000 may include a grid information generation unit 100, a shadow area determination unit 200, an initial object position information generation unit 300, an object position estimation unit 400, and a three-dimensional trajectory restoration unit 500.

The grid information generation unit 100 may use depth information extracted from a background of an image to generate a grid on a bottom plane and a rear plane and project three-dimensional position information extracted from the background of the image on the grid to calculate the number of points projected on the grid to thereby generate grid information.

Here, the depth information may refer to three-dimensional information that may be obtained using a depth sensor.

According to an embodiment of the present disclosure, a depth image of the background may be first obtained to find a shadow area, a grid may be generated on the bottom (XZ plane) and the rear (XY plane), and a plurality of points included in the three-dimensional position information obtained from the depth image of the background may be projected on the grid to calculate the number of the points included in the grid.

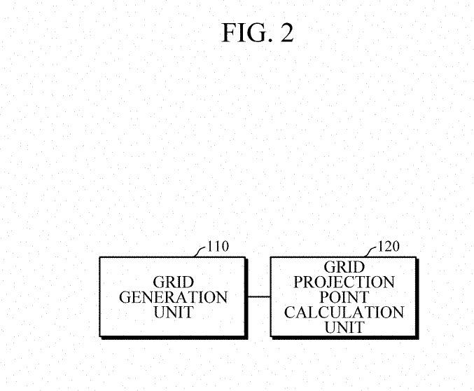

The grid information generation unit 100 will be described in more detail with reference to FIG. 2.

The shadow area determination unit 200 may extract three-dimensional position information from an image that has captured a user's swing motion to generate swing motion information including the number of points projected on the grid and may compare the number of the projected points included in the grid information with the number of the projected points included in the swing motion information to determine a shadow area of the object.

The depth sensor uses a time of flight (TOF) method and, since a distance is calculated by measuring an amount of time taken for emitted light to be reflected, light is reflected by an object when the object enters a sensor area, thus a shadow is formed at a rear portion of the object, and the shadow area refers to the area in which such a shadow is formed.

According to an embodiment of the present disclosure, when points other than the three-dimensional depth points due to a user or an instrument are projected on a grid, the depth points may almost not appear on a grid corresponding to a shadow, and this area is defined as the shadow area in the present disclosure.

According to an embodiment of the present disclosure, to determine the shadow area of the object, an entire shadow area and a shadow area of a user may be searched for, and the shadow area of the user may be excluded from the searched entire shadow area.

According to an embodiment of the present disclosure, to search for the shadow area of the user, since the user is standing at a central portion of the depth sensor, first, it may be determined whether a grid point (G_{xcyc}) corresponding to the center of a rear grid (G_{xy}) corresponds to the shadow area.

When the grid point (G_{xcyc}) corresponds to the shadow area, the grid point (G_{xcyc}) may be set as 1, may be input into a shadow area queue, and the first grid input into the queue may be a starting point for searching for the shadow area of a user.

Here, eight grid points adjacent to the starting grid point may be checked and, when corresponding to the shadow area, may be set as 1 and input into the shadow area queue. The grid points input into the shadow area queue may be sequentially taken out, checked whether the grid points correspond to the shadow area, and stored, and this process may be repeated until the shadow area queue becomes empty.

According to an embodiment of the present disclosure, an area (Gₓ_{ₖ}_{z}_{_{M-1}}←Gₓ_{ₖ}_{y}_{₀}=1) same as an x-axis index value (xₖ) of the grid at a point at which a ground grid (G_{xz}) meets the rear grid may be input into the queue as a starting point of the ground grid (G_{xz}), and adjacent grid points may be checked in the same way as the process described above.

The shadow area of a user may be extracted through the process above, and the process for searching for the shadow area of a user may be shown as a pseudo code below.

ShadowQueue.Add(G_{X}_{_{c}}_{Y}_{_{c}}), if (G_{X}_{_{c}}_{Y}_{_{c}} = 1)
for G_{cur} in ShadowQueue

for G_{neighbor} of G_{cur}, G_{neighbor} ≠ 1

if G_{neighbor} == depth shadow

G_{neighbor} = 1
ShadowQueue.Add(G_{neighbor})

According to an embodiment of the present disclosure, to determine the shadow area of the object, the number of points included in the grid may be calculated and the shadow area of the object may be determined from, the entire shadow area except the shadow area of a user.

According to the embodiment, one, or more shadow areas may be found, and the found shadow areas may be divided into blocks formed of adjacent grids.

Here, when there is one block, the block may be determined as the shadow area of the object. When two or more blocks are formed, a block relatively closer to a position predicted using a previous object shadow position and speed may be determined as the shadow area of the object.

According to an embodiment of the present disclosure, speed of an object at an instant when the object begins to move is 0, and because the speed is not fast up to a few frames, the shadow area of the object is measured to be large. Thus, the shadow area of the object may be easily searched for, and the found initial shadow area of the object may be used to determine the current position of the object by a previous position and speed.

According to the embodiment, whether depth data of the object is present on a line connecting the origin of a coordinate system to the central point of the shadow area of the object may be checked to acquire the depth data of the object within a few frames in which an initial swing is beginning. Here, the acquired depth data of the object may be used to compensate for the three-dimensional position of the object as well as a position of an occluded hand.

The initial object position information generation unit 300 may use the determined shadow area of the object to form a virtual swing plane based on the fact that swing motion is performed in a swing plane and may use the formed virtual swing plane to generate initial position information of the object.

According to an embodiment of the present disclosure, the virtual swing plane may be formed based on the fact that swing motion is performed in the swing plane, and the initial position information of the object may be generated by calculating initial three-dimensional positions of the object using the swing plane.

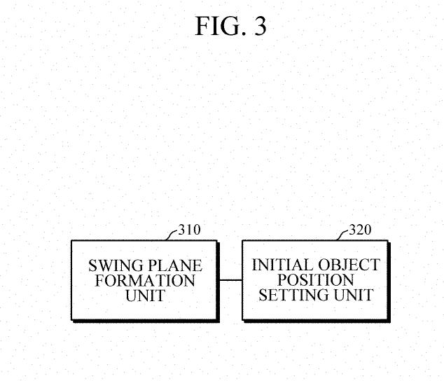

The initial object position information generation unit 300 will be described in more detail with reference to FIG. 3.

The object position estimation unit 400 may use the generated initial position information of the object and the shortest route information included in the swing motion information to estimate information on a position and speed of the user's hand and calculate an actual three-dimensional position of the object through the estimation.

According to an embodiment of the present disclosure, a hitting point at which the position of the user's hand is the most visible, i.e., a point at which a position of the shadow of the object is generated in the XZ plane, may be used as a starting point of tracking the user's hand.

When t+1 refers to an upward swing direction, i.e., a direction in which the hand moves to the rear, t−1 refers to a downward swing direction, i.e., a direction in which the hand moves to the front, Pₖ (k=1 . . . n) are three-dimensional depth points of the user, and ωₜ is a weight according to a distance between a position based on speed of the user's hand and a point, since the hand moves to the front near the hitting point according to an embodiment of the present disclosure, Equation 1 may be used, and a point closest to the initial three-dimensional position (iHEₜ) of the object on the virtual swing plane may be selected and set as an initial position (iHAₜ) of the user's hand.

l_{t±1}=|iHE_{t±1}−Pₖ|×ωₜ

ωₜ=|(iHAₜ+Vhₜ)−Pₖ|

iHA_{t±1}=Pₖ with shortest(l_{t±1}) [Equation 1]

A position and speed of the user's hand calculated in a current frame (t frame) may be used to track the position of the hand using a previous frame (t−1 frame) in the case of a downward swing and using the next frame (t+1 frame) in the case of an upward swing.

According to an embodiment of the present disclosure, the initial position of the user's hand tracked in each of the frames may be used to track the three-dimensional position of the object.

When it is assumed that the length L of an instrument held by the user is known, since the three-dimensional position of the object is on the line connecting the origin of the coordinate system to the shadow area of the object, a position on the line spaced apart by the length L from the initial position of the user's hand may be simply calculated using Equation 2 below.

T²=\vec{HA}²+L²−2\vec{HA}·L·cos(θ)

HE=\vec{OS}_{c}·T [Equation 2]

According to Equation 2 above, there are generally two solutions. A close point may be selected based on a three-dimensional position and speed of a previous object, a depth value of the object within initial two to three frames may be obtained when the user begins swinging, and, since the value becomes the actual three-dimensional position of the object, a position and speed of the object may be obtained based on the value.

The three-dimensional trajectory restoration unit 500 may use the calculated actual three-dimensional position of the object to restore three-dimensional trajectories of the user's hand and the object by curve fitting.

According to an embodiment of the present disclosure, the initial position of the user's hand may be compensated using the length of an instrument used by the user when the actual three-dimensional position information of the object is determined, and the position of the hand may be compensated to be a position moved by the length of the instrument from the actual three-dimensional position of the object when a position difference before and after the compensation is a preset threshold value or larger.

According to an embodiment of the present disclosure, due to the user's hand being occluded, there may be a difference between a position moved by the length L in a direction of the user's hand from the three-dimensional position of the object and the position of the user's hand.

According to the embodiment, when the actual three-dimensional position of the object is determined, the length L of the instrument may be used again to compensate for the initial position of the user's hand.

Here, when the difference between the two positions is a preset threshold value or larger, a better route of the hand may be calculated by compensating the position of the user's hand to be a position moved by the length L from the three-dimensional position of the object.

Particularly, since a few frames at an initial stage of swinging may obtain actual depth data of the object, compensating for the position of the user's hand based on the depth data may be more accurate.

According to an embodiment of the present disclosure, a spline curve or an elliptic equation may be used for curve fitting, and the spline curve or the elliptic equation may be used to calculate trajectories of the user's hand and the object.

FIG. 2 is a detailed block diagram of the grid information generation unit 100 shown in FIG. 1.

Referring to FIG. 2, the grid information generation unit 100 may include a grid generation unit 110 and a grid projection point calculation unit 120.

The grid generation unit 110 may′arrange a background on a three-dimensional space according to information on a principal point and a focal length of a camera included in the depth information extracted from the background of the image and generate a grid on a bottom plane and a rear plane of the arranged background according to a preset grid size.

According to an embodiment of the present disclosure, the depth information extracted from the background of the image may be arranged in three-dimensional space by applying the principal point and the focal length of the camera as in Equation 3.

W_{xy}=(I_{xy}−P_{xy})×D_{xy}/F_{xy}

W_{z}=D_{xy} [Equation 3]

Here, I represents a two-dimensional image pixel value, P represents a principal point, F represents a focal length, D represents a depth value, a point on the three-dimensional space is represented with W_{xyz}.

According to an embodiment of the present disclosure, grids (G_{xz}, G_{xy}) may be generated on the bottom (XZ plane) and the rear (XY plane), and the number of points projected on the grids may be counted and calculated.

According to an embodiment of the present disclosure, since a large amount of noise is generated at upper, lower, left, and right end portions of an image captured using a depth sensor, a grid may be generated by limiting the area to an area in which movement of the user including an instrument can be captured.

According to an embodiment of the present disclosure, the bottom grid is generated as Nₓ×M_{z}, and the rear grid is generated as Nₓ×M_{y}. Here, N and M which are numbers of grids may be determined by a preset grid size.

Here, a shadow area of a head may be missed when the grid size is too large, and a phenomenon in which the number of shadow areas being searched for increases may occur due to noise when the grid size is too small.

The grid projection point calculation unit 120 may project three-dimensional points included in the three-dimensional position information extracted from the background of the image on the generated grid and calculate the number of points projected on the grid to generate grid information.

According to an embodiment of the present disclosure, a position of a grid plane may be determined by an average height of the bottom and an average depth of a rear surface in the background, and, when a size and a position of the grid is determined, three-dimensional points may be projected on each grid, and then the number of the projected points (N_{Bij}) included in each grid may be calculated.

Here, i and j represent indices of a grid.

According to an embodiment of the present disclosure, the position of a designated object (P_{b}) may be found.

Here, the designated object refers to an object to be hit by an instrument held by the user's hand. For example, when the user swings a golf club using hands, a golf ball which the user desires to hit using the gold club may be the designated object.

According to an embodiment of the present disclosure, since the designated object is at a fixed position, a depth value may be obtained. An initial three-dimensional position of the designated object may be calculated using the depth value, and the calculated initial three-dimensional position may be used when forming a virtual swing plane.

FIG. 3 is a detailed block diagram of the initial object position information generation unit 300 shown in FIG. 1.

Referring to FIG. 3, the initial object position information generation unit 300 may include a swing plane formation unit 310 and an initial object position setting unit 320.

The swing plane formation unit 310 may form a virtual swing plane using an initial position of a designated object and a shadow area of an object having the highest y-axis value to track the position of the user's hand.

According to an embodiment of the present disclosure, a shadow formed on the background may signify that a three-dimensional position of the object is present on the line connecting the origin of the coordinate system of the camera to the shadow area of the object.

However, additional information is required since it is impossible to find a portion of the line where the position of the object is present, and the position of the user's hand may be tracked to be used as such additional information.

According to an embodiment of the present disclosure, to accurately track the position of the user's hand, a virtual swing plane may be formed based on the fact that swing motion is performed along a swing plane.

According to an embodiment of the present disclosure, the virtual swing plane may be generated using an initial position of a ball (P_{b}) and the shadow area of the object having the highest y-axis value using Equation 4 below.

V_{S}=(Pₘₐₓ+C_{Z})−Pₕ

V_{X}=(1,0,0)

N_{P}=Normal(V_{S}×V_{X}) [Equation 4]

Here, Pₘₐₓ is a position in which a y-axis value is the highest in the shadow area of the object, a vector C_{Z} that compensates for a depth value is a value for approaching a range within which the object moves, and N_{P} may be a normal vector of the virtual swing plane.

The initial object position setting unit 320 may set, as an initial position of the object (iHEₜ) a point at which a line connecting, the origin of a coordinate system of the camera to the shadow area of the object meets the formed swing plane.

According to an embodiment of the present disclosure, the generated virtual swing plane may convert a position of the object that is present on a two-dimensional grid into a three-dimensional position.

Here, a reason for converting the position of the object into a three-dimensional position is to track the three-dimensional position of the user's hand.

According to the embodiment, the position of the hand may be relatively more accurately tracked using the initial three-dimensional position of the object on the virtual swing plane than directly tracking the position of the hand in the shadow area of the object.

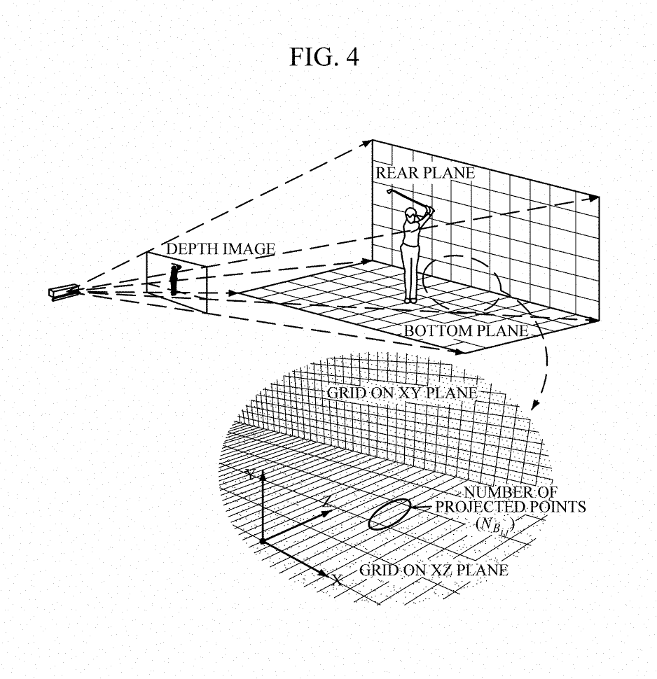

FIG. 4 is a view illustrating a generated grid and points projected on the grid according to an embodiment of the present disclosure.

Referring to FIG. 4, the grids (G_{xz}, G_{xy}) may be generated on the bottom (XZ plane) and the rear (XY plane), and the number of projected points (N_{Bij}) included in the grids may be counted and calculated.

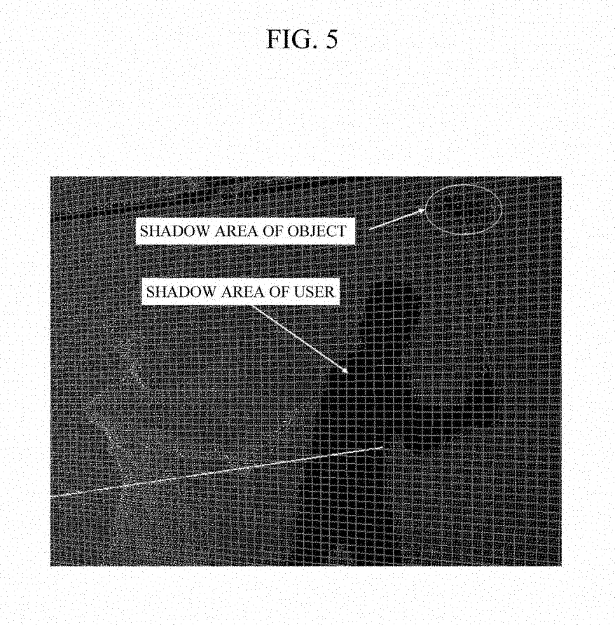

FIG. 5 is a view illustrating an entire shadow area generated according to an embodiment of the present disclosure.

Referring to FIG. 5, an entire shadow area generated according to an embodiment of the present disclosure is shown.

According to an embodiment of the present disclosure, a shadow caused by an object may be generated in a grid area, and shadows S(i,j) and S(i,j) may be determined as being cases of decreasing to a predetermined ratio (α) or lower compared to the number of projected points (N_{Bij}) in each grid calculated in advance in registering of the background.

Here, N_{Fij} may refer to the number of points included in a grid when portions of the current frame except a three-dimensional depth value of the user and the instrument are projected on the grid.

According to an embodiment of the present disclosure, Sᵢⱼ may be calculated using Equation 5.

S(i,j)=true, if (N_{Fij}<(N_{Bij}×α))

=false, else [Equation 5]

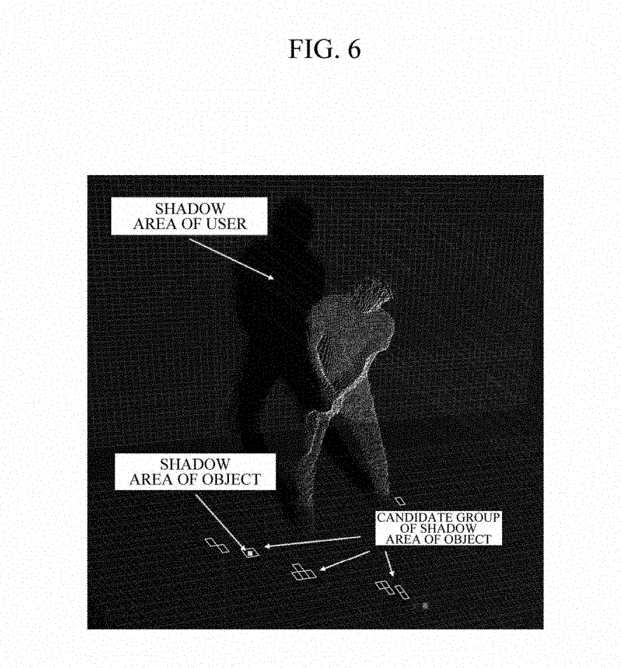

FIG. 6 is a view illustrating a shadow area of a user and a shadow area of an object generated according to an embodiment of the present disclosure.

Referring to FIG. 6, the shadow area of the user and the shadow area of the object are displayed on the grid.

According to an embodiment of the present disclosure, several shadow areas of the object may appear, and the shadow area of the object may be determined by dividing the several shadow areas into adjacent areas and selecting the most suitable one.

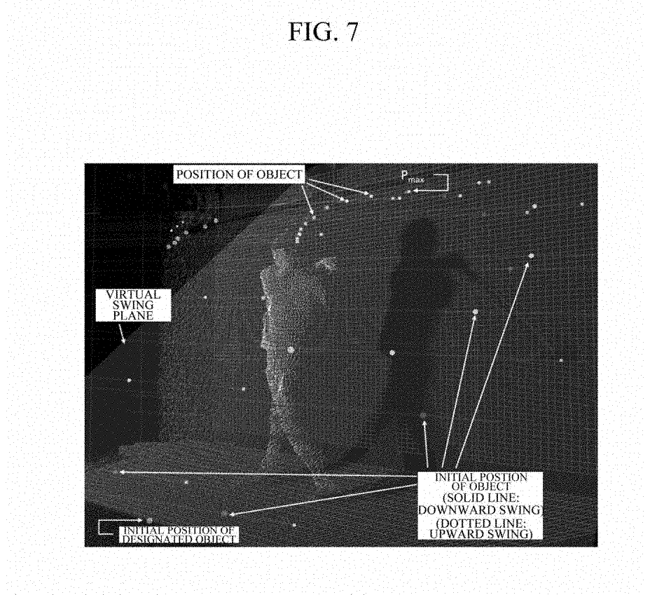

FIG. 7 is a view illustrating a formed virtual swing plane and an initial three-dimensional position of an object generated according to an embodiment of the present disclosure.

Referring to FIG. 7, a generated virtual swing plane and an initial position of the object are illustrated for when a point at which the line connecting the origin of the coordinate system of the camera to the shadow area of the object meets the virtual swing plane is set as an initial position of the object (iHEₜ) according to an embodiment of the present disclosure.

According to an embodiment of the present disclosure, the virtual swing plane may convert a position of the object on a two-dimensional grid into a three-dimensional position, and from this, the three-dimensional position of the user's hand may be tracked.

According to the embodiment, the initial position of the object on the virtual swing plane may be relatively more accurate than directly tracking the position of the user's hand in the shadow area of the object.

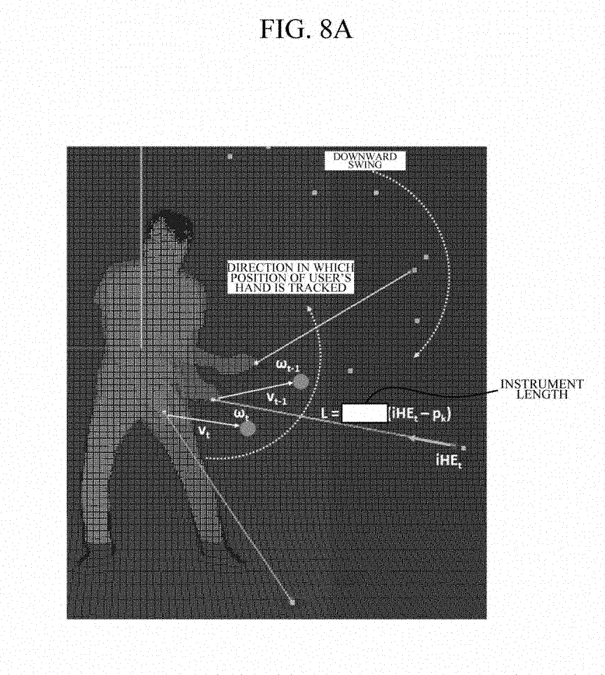

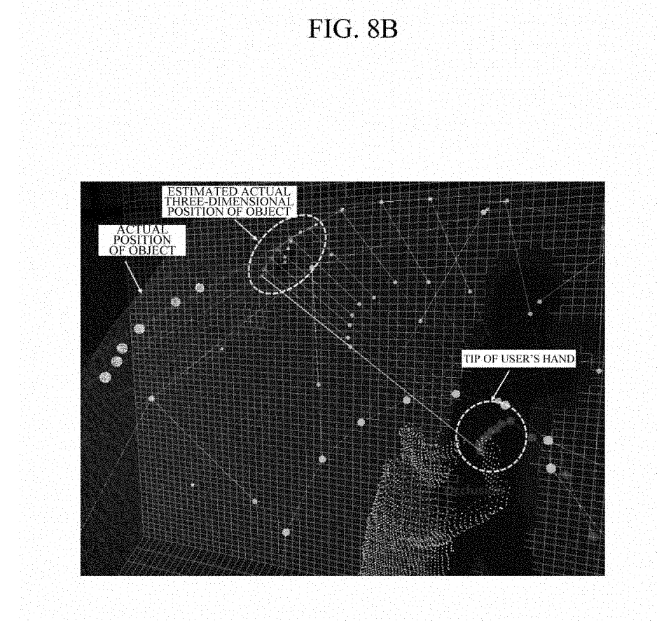

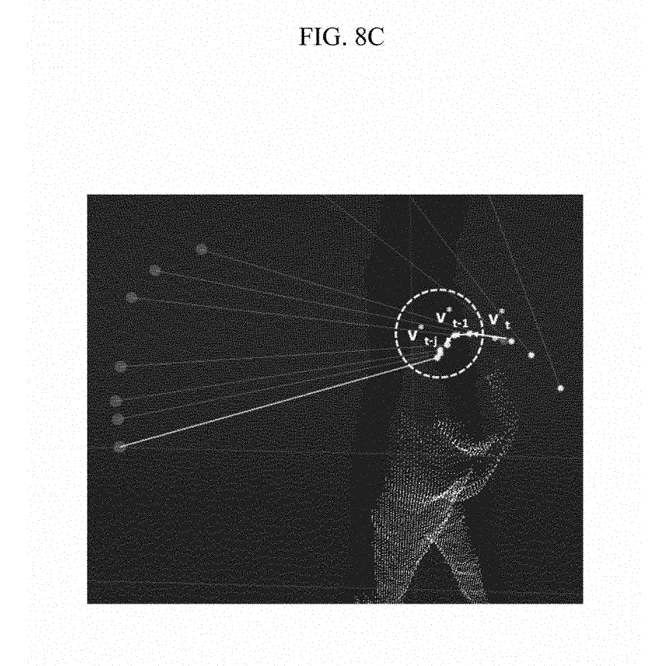

FIG. 8A is a view illustrating estimating a position of a user's hand according to an embodiment of the present disclosure.

FIG. 8B is a view illustrating the position of the user's hand being erroneously estimated due to the hand being occluded.

FIG. 8C is a view illustrating compensating for the position of the user's hand using information on an initial position and speed of the user's hand according to an embodiment of the present disclosure.

According to an embodiment of the present disclosure, there is a possibility of a hand portion being occluded according to the time at which the user hits the object since depth information is obtained from a single depth sensor. When the occlusion occurs, since it becomes difficult to find a position of the tip of the hand holding an instrument, a hitting point at which the position of the user's hand is the most visible, i.e., a point at which a position of the shadow of the object is generated on the XZ plane, may be used as a starting point of tracking the user's hand.

As described above, according to an embodiment of the present disclosure, the point at which the position of the shadow of the object is generated on the XZ plane may be set as a starting point of tracking the user's hand to track the position of the user's hand using Equation 1, a point closest to the initial position of the object (iHEₜ) on the swing plane may be selected and defined as the initial position of the user's hand (iHAₜ), and a position and speed of the user's hand calculated in the current frame (t frame) may be used to track the position of the hand using the previous frame (t−1 frame) in the case of a downward swing and using the next frame (t+1 frame) in the case of an upward swing.

Referring to FIG. 8A, t+1 may refer to an upward swing direction (a direction in which the hand moves to the rear), t−1 may refer to a downward swing direction (a direction in which the hand moves to the front), Pₖ (k=1 . . . n) may refer to three-dimensional depth points of the user, and ωₜ may refer to a weight for a distance between a position base on the speed of the user's hand and a point.

Referring to FIG. 8B, when the user's hand moves toward the rear, an occlusion phenomenon occurs, and it becomes difficult to accurately track the position of the user's hand.

Consequently, according to an embodiment of the present disclosure, when a difference between the position of the user's hand and a position and direction predicted by the speed is a threshold value or larger as in FIG. 8C, the predicted value may be set as the initial position of the user's hand.

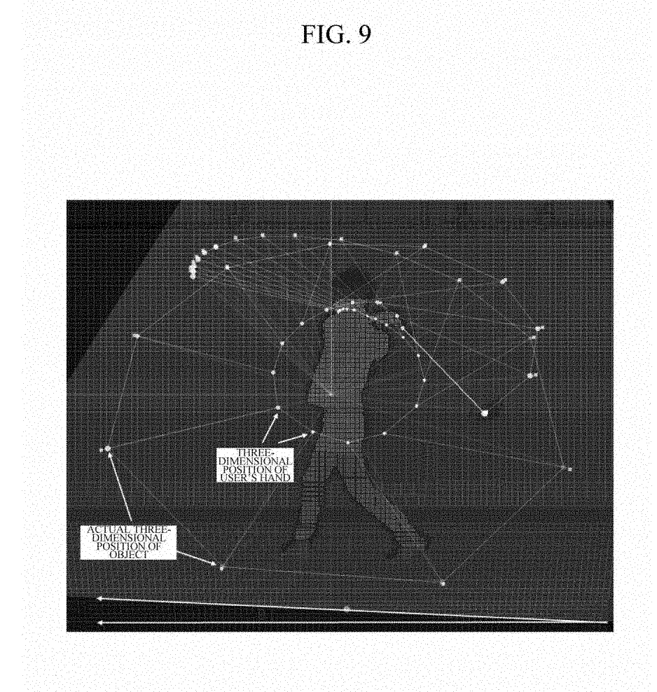

FIG. 9 is a view illustrating tracking the three-dimensional positions of the user's hand and the object by curve fitting using an actual three-dimensional position of the object according to an embodiment of the present disclosure.

Referring to FIG. 9, tracking the three-dimensional positions of the user's hand and the object by curve fitting is shown. A position searched near the user may be the three-dimensional position of the user's hand, and an outer portion thereof may be the three-dimensional position of the object.

According to an embodiment of the present disclosure, a new swing plane based on the position of the user's hand may be calculated by the curve fitting as in FIG. 9, and, accordingly, a difference of θ may occur with the x-axis.

The angular difference may analyze that a swing is performed inward in the case of a golf swing, thereby generating and providing information required in guiding the user to correct posture.

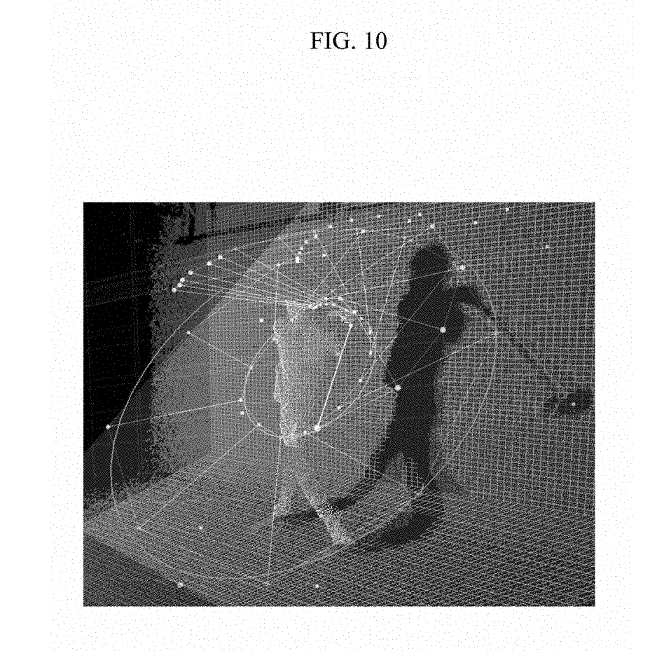

FIG. 10 is a view illustrating restoring three-dimensional trajectories of the user's hand and the object according to an embodiment of the present disclosure.

According to an embodiment of the present disclosure, the acquired positions of the user's hand and the object may be used to perform curve fitting and calculate trajectories of the user's hand and the object.

Here, a spline curve, an elliptic equation, etc. may be used as methods for curve fitting. However, the methods are not limited thereto, and any method may be used as long as the method is capable of performing curve fitting.

Referring to FIG. 10, results of trajectories of the user's hand and the object obtained by performing curve fitting using an elliptic equation in consideration of a swing plane are shown.

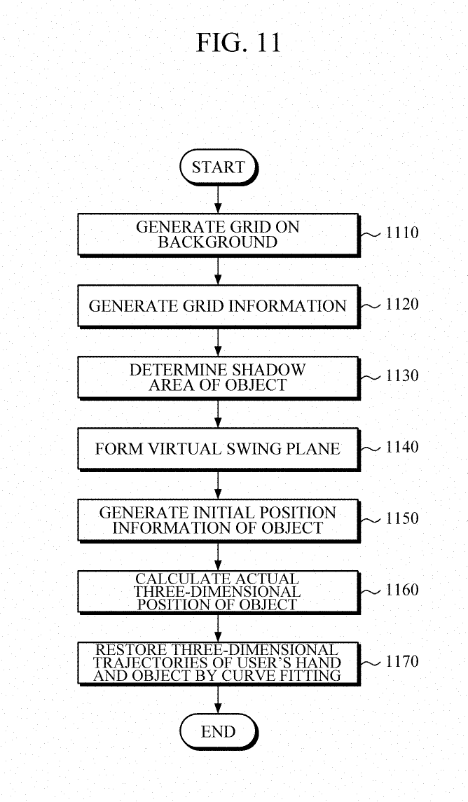

FIG. 11 is a flow chart illustrating a method of restoring the three-dimensional trajectory of the user's hand and the object according to an embodiment of the present disclosure.

A grid is formed on a background (S1110).

According to an embodiment of the present disclosure, a background may be arranged in three-dimensional space according to information on a principal point and a focal length of a camera included in the depth information extracted from the background of the image acquired from a depth sensor, and a grid may be generated on a bottom plane and a rear plane of the arranged background according to a preset grid size.

According to an embodiment of the present disclosure, the depth information extracted from the background of the image may be arranged in three-dimensional space by applying the principal point and the focal length of the camera as in Equation 3. Here, I represents a two-dimensional image pixel value, P represents a principal point, F represents a focal length, D represents a depth value, and a point on the three-dimensional space is represented with W_{xyz}.

According to an embodiment of the present disclosure, grids (G_{xz}, G_{xy}) may be generated on the bottom (XZ plane) and the rear (XY plane), and the number of points projected on the grids may be counted and calculated.

Grid information is generated (S1120).

According to an embodiment of the present disclosure, three-dimensional points included in the three-dimensional position information extracted from the background of the image may be projected on the generated grid, and the number of the points projected on the grid may be calculated to generate grid information.

According to an embodiment of the present disclosure, a position of a grid plane may be determined by an average height of the bottom and an average depth of the rear surface in the background, and, when the size and the position of the grid is determined, three-dimensional points may be projected on each grid, and then the number of projected points (N_{Bij}) included in each grid may be calculated.

According to an embodiment of the present disclosure, the position of a designated object (P_{b}) may be found.

The shadow area of the object is determined (S1130).

Three-dimensional position information may be extracted from an image that has captured a user's swing motion to generate swing motion information including the number of points projected on the grid and the number of the projected points included in the grid information may be compared with the number of the projected points included in the swing motion information, and a shadow area of the object may be determined.

The depth sensor uses a time of flight (TOF) method and, since a distance is calculated by measuring an amount of time taken for united light to be reflected, light is reflected by an object when the object enters a sensor area, and thus a shadow is formed at a rear portion of the object, and the shadow area refers to the area in which such a shadow is formed.

According to an embodiment of the present disclosure, when points other than the three-dimensional depth points due to a user or an instrument are projected on a grid, the depth points may almost not appear on a grid corresponding to a shadow, and this area is defined as the shadow area in the present disclosure.

According to an embodiment of the present disclosure, to determine the shadow area of the object, an entire shadow area and a shadow area of a user may be searched for, and the shadow area of the user may be excluded from the searched entire shadow area.

According to an embodiment of the present disclosure, to search for the shadow area of the user, since the user is standing at a central portion of the depth sensor, first, it may be determined whether a grid point (G_{xcyc}) corresponding to the center of a rear grid (G_{xy}) corresponds to the shadow area.

When the grid point (G_{xcyc}) corresponds to the shadow area, the grid point (G_{xcyc}) may be set as 1, may be input into a shadow area queue, and the first grid input into the queue may be a starting point for searching for the shadow area of the user.

Here, eight grid points adjacent to the starting grid point may be checked and, when corresponding to the shadow area, may be set as 1 and input into the shadow area queue. The grid points input into the shadow area queue may be sequentially taken out, checked whether the grid points correspond to the shadow area, and stored, and this process may be repeated, until the shadow area queue becomes empty.

According to an embodiment of the present disclosure, an area (Gₓ_{ₖ}_{z}_{_{M-1}}←Gₓ_{ₖ}_{y}_{₀}=1) same as an x-axis index value (xₖ) of the grid at a point at which the ground grid (G_{xz}) meets the rear grid may be input into the queue as a starting point of the ground grid (G_{xz}), and adjacent grid points may be checked in the same way as the process described above.

According to an embodiment of the present disclosure, to determine the shadow area of the object, the number of points included in the grid may be calculated and the shadow area of the object may be determined in the entire shadow area except the shadow area of the user.

According to the embodiment, one or more shadow areas may be found, and the found shadow areas may be divided into blocks formed of adjacent grids.

Here, when there is one block, the block may be determined as the shadow area of the object. When two or more blocks are generated, a block relatively closer to a position predicted using a previous object shadow position and speed may be determined as the shadow area of the object.

According to an embodiment of the present disclosure, speed of an object at an instant when the object begins to move is 0, and because the speed is not fast up to a few frames, the shadow area of the object is measured to be large. Thus, the shadow area of the object may be easily searched for, and the searched initial shadow area of the object may be used to determine the current position of the object by a previous position and speed.

A virtual swing plane is formed (S1140).

According to an embodiment of the present disclosure, to track the position of the user's hand, a virtual swing plane may be formed using an initial position of a designated object and a shadow area of an object having the highest y-axis value.

According to an embodiment of the present disclosure, a shadow formed on the background may signify that a three-dimensional position of the object is present on the line connecting the origin of the coordinate system of the camera to the shadow area of the object.

However, additional information is required since it is impossible to find a portion of the line where the position of the object is present, and the position of the user's hand may be tracked to be used as the additional information.

According to an embodiment of the present disclosure, to accurately track the position of the user's hand, the virtual swing plane may be formed based on the fact that swing motion is performed along the swing plane.

According to an embodiment of the present disclosure, the virtual swing plane may be generated using an initial position of a ball (P_{b}) and the shadow area of the object having the highest y-axis value using Equation 4.

Initial position information of the object is generated (S1150).

According to an embodiment of the present disclosure, a point at which a line connecting the origin of the coordinate system of the camera to the shadow area of the object meets the formed swing plane may be set as an initial position of the object (iHEₜ).

According to an embodiment of the present disclosure, the generated virtual swing plane may convert the position of the object that is present on a two-dimensional grid into a three-dimensional position.

Here, a reason for converting the position of the object into a three-dimensional position is to track the three-dimensional position of the user's hand.

According to the embodiment, the position of the hand may be relatively more accurately tracked using the initial three-dimensional position of the object on the virtual swing plane than directly tracking the position of the hand in the shadow area of the object.

An actual three-dimensional position of the object is calculated (S1160).

The generated initial position information of the object and the shortest route information included in the swing motion information may be used to estimate information on a position and speed of the user's hand, and an actual three-dimensional position of the object may be calculated through the estimation.

According to an embodiment of the present disclosure, a hitting point at which the position of the user's hand is the most visible, i.e., a point at which a position of the shadow of the object is generated on the XZ plane, may be used as a starting point of tracking the user's hand.

When t+1 refers to an upward swing direction, i.e., a direction in which the hand moves to the rear, t−1 refers to a downward swing direction, i.e., a direction in which the hand moves to the front, Pₖ (k=1 . . . n) are three-dimensional depth points of the user, and ωₜ is a weight according to a distance between a position based on speed of the user's hand and a point, since the hand moves to the front near the hitting point according to an embodiment of the present disclosure, Equation 1 may be used, and a point closest to the initial three-dimensional position (iHEₜ) of the object on the virtual swing plane may be selected and set as an initial position (iHAₜ) of the user's hand.

A position and speed of the user's hand calculated in the current frame (t frame) may be used to track the position of the hand using the previous frame (t−1 frame) in the case of a downward swing and using the next frame (t+1 frame) in the case of an upward swing.

According to an embodiment of the present disclosure, the initial position of the user's hand tracked in each of the frames may be used to track the three-dimensional position of the object.

When it is assumed that the length L of an instrument held by the user is known, since the three-dimensional position of the object is on the line connecting the origin of the coordinate system to the shadow area of the object, a position on the line spaced apart by the length L from the initial position of the user's hand may be simply calculated using Equation 2.

According to Equation 2, there are generally two solutions. A close point may be selected based on a three-dimensional position and speed of a previous object, a depth value of the object within initial two to three frames may be obtained when the user begins swinging, and, since the value becomes the actual three-dimensional position of the object, a position and speed of the object may be obtained based on the value.

Three-dimensional trajectories of the user's hand and the object are restored by curve fitting (S1170).

According to an embodiment of the present disclosure, the calculated actual three-dimensional position of the object may be used to restore three-dimensional trajectories of the user's hand and the object by curve fitting.

According to an embodiment of the present disclosure, the initial position of the user's hand may be compensated using the length of an instrument used by the user when the actual three-dimensional position information of the object is determined.

Here, the position of the hand may be compensated to be a position moved by the length of the instrument from the actual three-dimensional position of the object when a position difference between before and after the compensation is a preset threshold value or larger.

According to an embodiment of the present disclosure, due to the user's hand being occluded, there may be a difference between a position moved by the length L in the direction of the user's hand from the three-dimensional position of the object and the position of the user's hand.

According to the embodiment, when the actual three-dimensional position of the object is determined, the length L of the instrument may be used again to compensate for the initial position of the user's hand.

Here, when the difference between the two positions is a preset threshold value or larger, a better route for the hand may be calculated by compensating the position of the user's hand to be a position moved by the length L from the three-dimensional position of the object.

Particularly, since a few frames at an initial stage of swinging may obtain actual depth data of the object, compensating for the position of the user's hand based on the depth data may be more accurate.

According to an embodiment of the present disclosure, a spline curve or an elliptic equation may be used for curve fitting, and the spline curve or the elliptic equation may be used to calculate trajectories of the user's hand and the object.

According to the present disclosure, a three-dimensional route of an object, for which it is difficult to acquire depth information, for fast sports motion is tracked such that information that allows a user to correct and learn motion can be provided, and a three-dimensional position and route are calculated unlike in conventional two-dimensional image methods such that information required for practicing a more accurate swing motion can be provided.

Further, the three-dimensional position of a high-speed moving object that cannot be provided using a conventional sports posture comparison technology that only uses depth information on a user's posture is tracked such that a posture comparison can be performed more effectively.

Further, only a single depth sensor is used without an attachment or wearing of a suit, a marker, and a sensor such as a conventional optical sensor and an inertia sensor that cause inconvenience in movement such that motion can be learned conveniently.

Embodiments of the present disclosure are not implemented only through the apparatus and/or the method described above. Although the embodiments of the present disclosure have been described in detail above, the scope of the present disclosure is not limited thereto, and various modifications and improvements to be made by those of ordinary skill in the art using a basic concept of the present disclosure defined in the claims below also belong to the scope of the present disclosure.

What is claimed is:

1. An apparatus for tracking a trajectory of a high-speed moving object, the apparatus comprising:
a grid information generation unit configured to generate a grid on a bottom plane and a rear plane using depth information extracted from a background of an image and project three-dimensional position information extracted from the background of the image on the grid to generate grid information;
a shadow area determination unit configured to extract three-dimensional position information from an image that has captured a user's swing motion to generate swing motion information including the number of points projected on the grid and use the grid information and the swing motion information to determine a shadow area of an object;
an initial object position information generation unit configured to generate information on an initial position of the object by a virtual swing plane formed using the determined shadow area of the object to form;
an object position estimation unit configured to use the generated initial position information of the object and shortest route information included in the swing motion information to estimate information on a position and speed of a user's hand to calculate an actual three-dimensional position of the object; and
a three-dimensional trajectory restoration unit configured to use the calculated actual three-dimensional position of the object to restore three-dimensional trajectories of the user's hand and the object by curve fitting.

2. The apparatus of claim 1, wherein the grid information generation unit includes:
a grid generation unit configured to dispose a background in three-dimensional space according to information on a principal point and a focal length of a camera included in the depth information extracted from the background of the image and generate a grid on a bottom plane and a rear plane of the disposed background according to a preset grid size; and
a grid projection point calculation unit configured to project three-dimensional points included in the three-dimensional position information extracted from the background of the image on the generated grid and calculate the number of points projected on the grid to generate grid information.

3. The apparatus of claim 1, wherein the shadow area determination unit searches for an entire shadow area and a shadow area of the user to determine the shadow area of the object and excludes the shadow area of the user from the searched entire shadow area.

4. The apparatus of claim 1, wherein the initial object position information generation unit includes:
a swing plane formation unit configured to form a virtual swing plane using an initial position of a designated object and a shadow area of an object having the highest y-axis value to track a position of the user's hand; and
an initial object position setting unit configured to set, as an initial position of the object, a point at which a line connecting the origin of a coordinate system of the camera to the shadow area of the object meets the formed swing plane.

5. The apparatus of claim 1, wherein the object position estimation unit sets a point at which a position of a shadow of an object is generated on an XZ plane as a starting point of tracking the user's hand to track a position of the user's hand, selects a point closest to the initial position of the object in the swing plane and define the point as an initial position of the user's hand, and uses a position and speed of the user's hand calculated in the current frame (t frame) to track the position of the hand using a previous frame (t−1 frame) in the case of a downward swing and using the next frame (t+1 frame) in the case of an upward swing.

6. The apparatus of claim 1, wherein the three-dimensional trajectory restoration unit compensates for the initial position of the user's hand using the length of an instrument used by the user when the actual three-dimensional position information of the object is determined and compensates for the position of the hand to be a position moved by the length of the instrument from the actual three-dimensional position of the object when a position difference between before and after the compensation is a preset threshold value or larger.

7. The apparatus of claim 1, wherein the three-dimensional trajectory restoration unit uses a spline curve or an elliptic equation for the curve fitting and uses the spline curve or the elliptic equation to calculate trajectories of the user's hand and the object.

8. The apparatus of claim 1, wherein the grid information generation unit calculates the number of the points projected on the grid to generate the grid information of the image.

9. The apparatus of claim 1, wherein the shadow area determination unit compares the number of projected points included in the grid information with the number of projected points included in the swing motion information to determine the shadow area of the object.

10. The apparatus of claim 1, wherein the initial object position information generation unit uses the determined shadow area of the object to form a virtual swing plane based on the fact that a swing motion is performed in a swing plane and uses the formed virtual swing plane to generate the information on the initial position of the object.

11. A method for tracking a trajectory of a high-speed moving object, the method comprising:
generating grid information by generating a grid on a bottom plane and a rear plane using depth information extracted from a background of an image and projecting three-dimensional position information extracted from the background of the image on the grid;
determining a shadow area of an object by extracting three-dimensional position information from an image that has captured a user's swing motion to generate swing motion information including the number of points projected on the grid and using the swing motion information;
generating information on an initial position of the object by a virtual swing plane formed using the determined shadow area of the object;
calculating an actual three-dimensional position of the object by using the generated initial position information of the object and shortest route information included in the swing motion information to estimate information on a position and speed of a user's hand; and
restoring three-dimensional trajectories of the user's hand and the object by curve fitting using the calculated actual three-dimensional position of the object.

12. The method of claim 11, wherein the generating of the grid information includes:
arranging a background on a three-dimensional space according to information on a principal point and a focal length of a camera included in the depth information extracted from the background of the image and generating a grid on a bottom plane and a rear plane of the arranged background according to a preset grid size; and
projecting, on the generated grid, three-dimensional points included in the three-dimensional position information extracted from the background of the image and calculating the number of the points projected on the grid to generate grid information.

13. The method of claim 11, wherein the determining of the shadow area of the object includes:
searching for an entire shadow area and a shadow area of the user to determine the shadow area of the object; and
excluding the shadow area of the user from the searched entire shadow area.

14. The method of claim 11, wherein the generating of the initial position information of the object includes:
forming a virtual swing plane using an initial position of a designated object and a shadow area of an object having the highest y-axis value to track a position of the user's hand; and
setting, as an initial position of the object, a point at which a line connecting an origin of a coordinate system of the camera to the shadow area of the object meets the formed swing plane.

15. The method of claim 11, wherein the calculating of the actual three-dimensional position of the object includes:
setting a point at which a position of a shadow of an object is generated on an XZ plane as a starting point of tracking the user's hand to track a position of the user's hand;
selecting a point closest to the initial position of the object on the swing plane and defining the point as an initial position of the user's hand; and
using a position and speed of the user's hand calculated in the current frame (t frame) to track the position of the hand using a previous frame (t−1 frame) in the case of a downward swing and using the next frame (t+1 frame) in the case of an upward swing.

16. The method of claim 11, wherein the restoring of the three-dimensional trajectory of the object includes:
compensating for the initial position of the user's hand using the length of an instrument used by the user when the actual three-dimensional position information of the object is determined; and
compensating for the position of the hand to be a position moved by the length of the instrument from the actual three-dimensional position of the object when a position difference between before and after the compensation is a preset threshold value or larger.

17. The method of claim 11, wherein the restoring of the three-dimensional trajectory of the object includes:
using a spline curve or an elliptic equation for the curve fitting; and
using the spline curve or the elliptic equation to calculate trajectories of the user's hand and the object.

18. The method of claim 11, wherein the generating of the grid information generation unit includes calculating the number of the points projected on the grid to generate the grid information of the image.

19. The method of claim 11, wherein the determining of the shadow area of the object includes comparing the number of projected points included in the grid information with the number of projected points included in the swing motion information to determine the shadow area of the object.

20. The method of claim 11, wherein the generating of the information on the initial position of the object includes using the determined shadow area of the object to form a virtual swing plane based on the fact that a swing motion is performed in a swing plane and using the formed virtual swing plane to generate the information on the initial position of the object.
